(19) United States
(12) Patent Application Publication
(10) Pub. No.: US 2004/0189185 A1
(43) Pub. Date: Sep. 30, 2004

(54) Light emitting display panel and method of manufacturing the same

(76) Inventor: Shinichi Yotsuya, Chino-shi (JP)

Correspondence Address: HARNESS, DICKEY & PIERCE, P.L.C., P.O. BOX 828, BLOOMFIELD HILLS, MI, 48303, US

(21) Appl. No.: 10/770,858

(22) Filed: Feb. 3, 2004

(30) Foreign Application Priority Data
Feb. 3, 2003 (JP) 2003-025730

(51) Int. Cl. H01J 5/16; H01K 1/26

(52) U.S. Cl. 313/501; 313/110; 313/112

(57) ABSTRACT

A light emitting display panel and a manufacturing method thereof capable of improving an extraction efficiency of emitted light, preventing reflection of incident light from outside as well as appearance of the image display, and enhancing current efficiency and a life of the panel including the light emitting element are provided. The light emitting display panel comprises a transparent substrate equipped with a light emitting element on a first surface thereof, a second surface of the transparent substrate defining a display surface; and a microlens array disposed above the second surface of the transparent substrate 1. The method of manufacturing the light emitting display panel comprises the step of adhering the microlens array with the second surface of the transparent substrate via adhesive.

### BACKGROUND

1. Field of the Invention

The present invention relates to a light emitting display panel using a light emitting element such as an organic electroluminescent (hereinafter referred to as an organic EL) element and a manufacturing method for the light emitting display panel.

2. Description of the Related Art

In a conventional light emitting display panel, a light emitting layer (a plurality of light emitting elements) having a plurality of transparent electrodes parallel to each other, an organic EL material layer, and a metal electrode stacked in this order is formed on a transparent substrate. Further, terminal lines extending from the transparent electrodes and the metal electrode are formed to connect a drive circuit. The light emitting layer is held in a sealed environment provided by adhering a sealing case to the transparent substrate via adhesive, thus preventing deterioration of light emitting efficiency caused by atmospheric moisture.

The conventional light emitting display panel as described above has a structure in which the light emitting elements are disposed on one surface of the transparent substrate and display light is emitted from the other surface of the transparent substrate. However, since the emitted light is diffused in various directions and the refractive index of the transparent substrate made of glass (typically 1.50 in case of glass) is higher than that of atmosphere (air, typically 1.00), total reflection occurs at a boundary face between the transparent substrate and the atmosphere on the emitted light that makes a larger angle relative to the normal to the surface of the transparent substrate than the critical angle, which causes a problem of lower light-extraction efficiency because such light is diffused in the transparent substrate or disappears by attenuation through the transparent substrate. Further explanation is described herein using some specific values. The light-extraction efficiency of the emitted light is given by the following equation (1) where n denotes the refractive index of the transparent substrate.

Light-extraction efficiency=1/(2n²) (1)

If the refractive index of glass, n=1.50 is applied to the equation (1), the light-extraction efficiency is given as 0.22, which shows that only 22% of emitted light can be utilized resulting in a large energy loss.

In addition, since a mirror finish is applied to the other surface of the transparent substrate that defines a display surface, incident light from outside is reflected by the surface, which causes a problem that the reflected light makes the display on the light emitting display panel difficult to recognize by mingling with the light emitted by the light emitting elements.

The present invention attempts to cope with the problems described above. Therefore, according to one aspect of the present invention, a light emitting display panel that can enhance the light-extraction efficiency, prevent reflection of the incident light from outside, and improve appearance of the display, a current efficiency, and a life of the panel including the light emitting elements and a manufacturing method thereof can be provided.

### SUMMARY

A light emitting display panel according to an embodiment of the present invention comprises: a transparent substrate equipped with a light emitting element on a first surface thereof, a second surface of the transparent substrate defining a display surface; and a microlens array disposed above the second surface of the transparent substrate. According to this structure, light from the light emitting elements becomes difficult to reflect by a boundary face between the transparent substrate and the atmosphere and also the incident light from outside can be diffusely reflected. Thus the light-extraction efficiency can be improved resulting in improvement of the light-emission efficiency, and it is also possible to prevent the display from becoming difficult to be recognized by preventing reflection of the incident light.

In addition, in the light emitting display panel described above, the microlens array can be adhered above the second surface of the transparent substrate via adhesive. According to this structure, concavity and convexity can be easily formed on the display face of the transparent substrate.

Furthermore, in the light emitting display panel described above, the microlens array can be disposed on a first surface of a substrate made of the same material as the transparent substrate, and a second surface of the substrate can be adhered to the second surface of the transparent substrate via adhesive. According to this structure, since the microlens array can be formed on a flat surface, microfabrication technologies can be utilized to form a very fine microlens array. Thus the reflection of the incident light can be prevented to provide a clearer image display in a bright condition, and also the microlens can be manufactured with fewer manufacturing steps, which can reduce the manufacturing costs of the light emitting display panel.

In the light emitting display panel described above, the microlens array can be made of a transparent material having a refractive index substantially equal to or higher than that of the transparent substrate. According to this structure, since the microlens array does not have a refractive index less than the transparent substrate, the light from the light emitting elements is output with little reflection by the boundary face between the transparent substrate and the microlens array. Moreover, the incident light from the transparent substrate side to the microlens array side with a large incident angle is output with a smaller angle than the incident angle. In other words, since the angle of a large part of the output light can be reduced to be smaller than the critical angle, little light is reflected by the total reflection phenomenon. Thus, the light-extraction efficiency can be improved resulting in improvement of the light-emission efficiency. Moreover, since the power consumption necessary for light emission can be reduced, the life of the light emitting elements can be extended.

Still further, in the light emitting display panel described above, the adhesive can be made of a transparent material having a refractive index that is substantially equal to or higher than that of the transparent substrate and substantially equal to or lower than that of the microlens array. According to this structure, since the microlens array does not have a refractive index less than the adhesive and the adhesive does not have a refractive index less than the transparent substrate, the light from the light emitting elements is output with little reflection caused by the total reflection at the boundary faces between the transparent substrate and the adhesive and between the adhesive and the microlens array, thus enhancing the light-extraction efficiency.

Moreover, in the light emitting display panel described above, the adhesive can be made of a material that cures at a temperature lower than that of a glass transition point of a material forming the light emitting element. According to this structure, the heat-sensitive light emitting elements are not damaged by heat applied to cure the adhesive when adhering the microlens array with the transparent substrate.

Furthermore, in the light emitting display panel described above, the adhesive can be made of a material cured by visible radiation. According to this structure, the light emitting elements which are sensitive to heat and ultraviolet lays are not damaged by ultraviolet lays irradiated to cure the adhesive when adhering the microlens array to the transparent substrate.

In the light emitting display panel described above, the microlens array can comprise a plurality of convex microlenses sized within a range of 1 through 100 micrometers. According to this structure, a high efficiency of reducing incident light reflection can be obtained, and thus enhance the light-extraction efficiency of the light emitting elements.

Furthermore, in the light emitting display panel described above, the light emitting element can be formed by sequentially stacking at least a transparent electrode, a light emitting layer, and a metal electrode above the first surface of the transparent substrate in this order.

Still further, in the light emitting display panel described above, the light emitting layer can comprise a layer of an organic EL material.

In addition, in the light emitting display panel described above, an antireflective agent may be applied on at least the second surface of the transparent substrate and the surface of the microlens array. According to this structure, reflection of the light emitted from the light emitting elements caused by the total reflection phenomenon and reflection of the incident light from outside can be reduced, thus enhancing the light-extraction efficiency. Accordingly, the light-emission efficiency can be improved, and the display appearance of the light emitting display panel can also be improved.

A method of manufacturing a light emitting display panel according to one embodiment of the present invention is applicable to a light emitting display panel equipped with a light emitting element on a first surface of a first transparent substrate and a microlens array on a second surface of the first transparent substrate, and comprises the steps of: (a) coating a second transparent substrate with resin; (b) transferring a shape of the microlens array to the resin by pressing a mold of the microlens array against the resin; (c) curing the resin; and (d) forming the microlens array by peeling off the mold from the resin. Here, step (d) can comprise the step of (e) peeling off the second transparent substrate from the resin. According to the above method, the microlens array can be easily formed of thermosetting resin. Thus the cost of the light emitting display panel can be reduced.

A method of manufacturing a light emitting display panel according to another embodiment of the present invention is applicable to a light emitting display panel equipped with a light emitting element on a first surface of a first transparent substrate and a microlens array on a second surface of the first transparent substrate, and comprises the steps of: (a) coating a second transparent substrate with photosensitive resin; (b) patterning the photosensitive resin by a photolithography process so that the photosensitive resin is formed on each pixel corresponding to a convex microlens of the microlens array; (c) shaping the patterned photosensitive resin into the convex microlens by heating the photosensitive resin; and (d) forming the microlens array by transferring a shape of the photosensitive resin to the second transparent substrate by simultaneously dry-etching the photosensitive resin and the second transparent substrate. According to the above method, since a hard substrate is directly processed to form the microlens array, the microlens array is durable against wear even if it is exposed to the outside. Thus a light emitting display panel having a durable surface can be provided.

### BRIEF DESCRIPTION OF THE DRAWINGS

FIG. 1 is a side elevation view for explaining a structure of a first embodiment of the present invention.

FIG. 2 is a side elevation view for explaining an action of the first embodiment of the present invention.

FIGS. 3A-D are sequential views of a manufacturing process for a microlens array according to the first embodiment.

FIG. 4 is a side elevation view for explaining a structure of a second embodiment of the present invention.

FIGS. 5A-C are sequential views of a manufacturing process for a microlens array according to the second embodiment.

FIGS. 6A-C are sequential views of a manufacturing process for a microlens array according to a third embodiment.

### DETAILED DESCRIPTION

First Embodiment

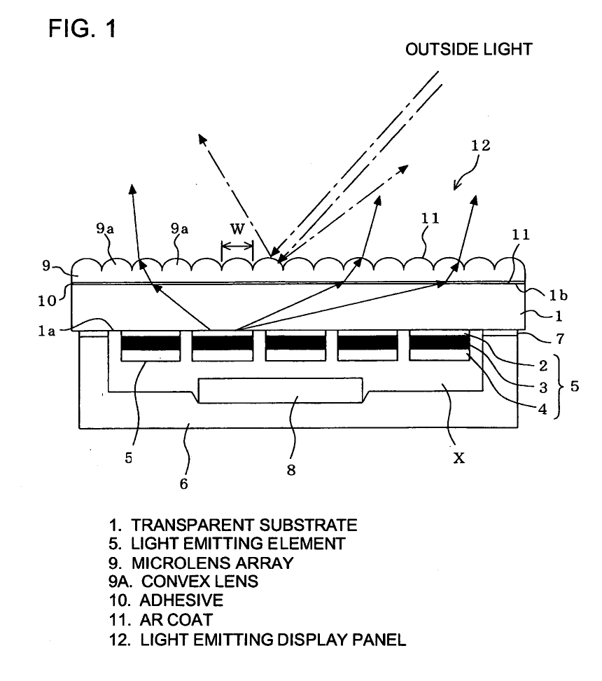

FIG. 1 is for explaining a structure of the first embodiment of the present invention. In the figure, reference numeral 1 denotes a transparent substrate. A plurality of light emitting elements (organic EL elements) 5 is disposed on a first surface (the lower surface) 1a of the transparent substrate 1. Each of the light emitting elements 5 is formed by sequentially stacking a transparent electrode 2 made of indium tin oxide (hereinafter referred to as ITO) or the like, an organic EL material layer 3 formed of a light emitting functional layer or multiple layers including at least the light emitting functional layer, and a metal electrode 4. A sealing member 6 made of, for example, glass, is disposed on the lower surface 1a of the transparent substrate 1 via adhesive 7 to seal the surrounding area of the light emitting elements. The sealing member 6 prevents a light emission property of the light emitting elements 5 from deteriorating due to moisture. A desiccating agent 8 is disposed on an inner surface of the sealing member 6 within a space X formed between the sealing member 6 and the transparent substrate 1 for drying the space X to prevent the light emission property of the light emitting elements 5 from deteriorating due to moisture.

A microlens array 9 made of a transparent material whose refractive index is substantially equal to or higher than that of the material forming the transparent substrate 1 such as acrylic resin or epoxy resin is adhered with the other surface (the upper surface) 1b of the transparent substrate 1 via adhesive 10. Since a plurality of convex microlenses (hereinafter referred to as convex lenses) 9a is disposed on one surface (the upper surface) of the transparent substrate 1 without any spaces, the surface is uneven. Note that the size (width) W of each of the convex lenses 9a is preferably in a range of 1 through 100 micrometers. This is because, if the width W is less than 1 micrometer, the unevenness of the surface of the microlens array 9 becomes too small to sufficiently reduce the reflection of the incident light from the outside (the dashed line arrow in FIG. 1) and, if the width W exceeds 100 micrometers, total reflection often occurs in the microlens array 9 especially in the convex lenses 9a resulting in a decline in extraction efficiency of the emitted light (the solid line arrow in FIG. 1), on the other hand.

The adhesive 10 is made of a transparent thermosetting resin whose refractive index is substantially equal to or lower than that of the microlens array 9 and substantially equal to or higher than that of the transparent substrate 1. A thermosetting resin that cures at a temperature lower than the lowest one of the glass transition points (Tg points) of the organic materials forming the light emitting element 5 is recommended. More preferably, the thermosetting resin should cure at a temperature at least 10 degrees centigrade lower than the lowest Tg point. This is because the light emitting element 5 that is sensitive to heat should be prevented from being damaged when the microlens array 9 is adhered with the transparent substrate 1. Moreover, since the light emitting element 5 is also sensitive to ultraviolet rays (UV), a thermosetting resin that cures with visible radiation is also preferable. Furthermore, an antireflection (AR) coat 11, that is, an antireflection agent, is applied to the surfaces of the microlens array 9 and transparent substrate 1 to prevent reflection of light emitted from the light emitting elements 5 and reflection of incident light from outside.

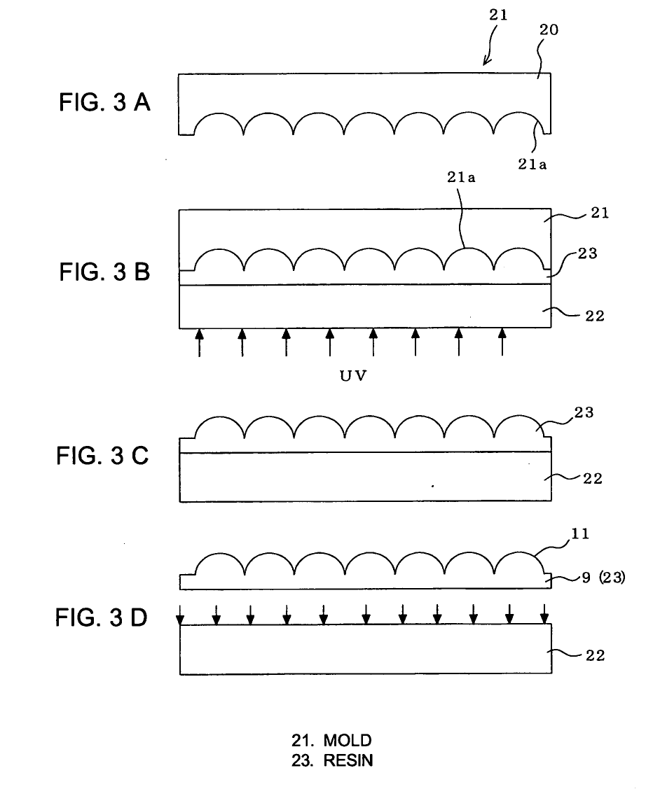

A method of manufacturing the microlens array 9 is explained herein using a process chart shown in FIGS. 3A-D.

As shown in FIG. 3A, first, polysilicon is applied on a outer surface of a quartz glass plate 20 that is to be a mold of the microlens array 9 with holes (i.e., depressions) provided on one surface (the lower surface) of the quartz glass plate 20, each hole corresponding to each of the convex lenses 9a, and then the quartz glass plate is wet-etched to form the mold 21. Then a water repellent finish is applied to the mold 21, especially the side of the concave portions 21 a thereof that make convex lenses 9a by blowing carbon fluoride (CF) gas that prevents adhesion thereto.

As shown in FIG. 3B, next, after applying the same water repellent finish to one surface (the upper surface) of a glass plate 22 as in case of the mold 21, thermosetting resin 23 that is to form the microlens array 9 is applied on the one surface (the upper surface) of the glass plate 22 with a predetermined thickness. The mold 21 is then adhered to the thermosetting resin 23 in a vacuum so that no bubbles invade between the mold 21 and the thermosetting resin 23. Then the thermosetting resin 23 is cured by irradiating light such as UV rays from the other surface (the lower surface) of the glass plate 22 to mold the thermosetting resin 23 into the shape of the mold 21.

As shown in FIG. 3C, next, the mold 21 is peeled from the cured thermosetting resin 23. Since the water repellent finish is applied to the concave portions 21a side of the mold 21, it is easy to peel off the mold 21.

As shown in FIG. 3D, then, after the thermosetting resin 23 is peeled from the glass plate 22, the AR coat is applied to the surface of the thermosetting resin 23 to complete the microlens array 9. At this time, since the water repellent finish is also applied to the glass plate 22, it is easy to peel off the thermosetting resin from the glass plate 22.

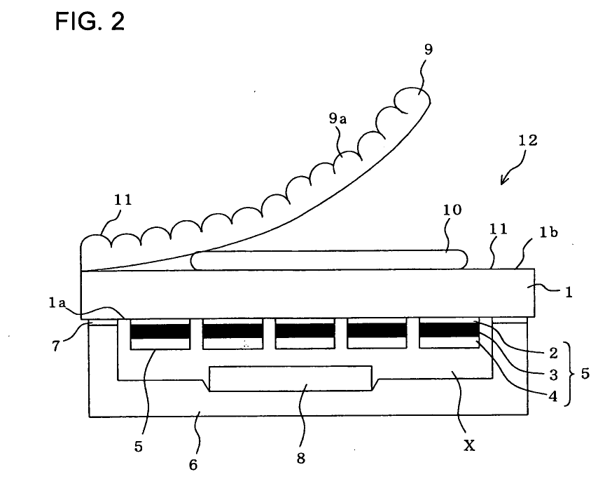

The microlens array 9 thus manufactured is adhered with the other surface (the upper surface) 1b of the transparent substrate 1 via the adhesive 10 as shown in FIG. 2, the transparent substrate 1 having the plurality of light emitting elements 5 on the one surface (the lower surface) 1a thereof sealed with the sealing member 6. This assembly, together with a circuit board not shown in the drawings having a drive circuit for driving the light emitting elements 5, forms the light emitting display panel 12.

In the light emitting display panel 12 thus structured, a desired one of the light emitting elements 5 emits light in accordance with the drive circuit in the circuit board, and the light is emitted to the outside via the transparent substrate 1 and the microlens array 9. In this case, since the adhesive 10 has a lower refractive index than the microlens array 9 and the transparent substrate 1 has a lower refractive index than the adhesive 10, the light from the light emitting elements 5 can be emitted without being reflected at any boundary surfaces between the transparent substrate 1 and the adhesive 10 or between the adhesive 10 and the microlens array 9. In addition, since the refractive index of the microlens array 9 is higher than those of the transparent substrate 1 and the adhesive 10, the incident light from the transparent substrate 1 side to the microlens array 9 side with a large incident angle is output with a smaller angle than the incident angle. In other words, since the angle of a large part of the output light can be reduced to be smaller than the critical angle, little light is reflected by the total reflection phenomenon. Thus, the extraction efficiency of the light from the light emitting elements 5 can be improved resulting in an improvement of the light-emission efficiency. Moreover, since the power consumption necessary for light emission can be reduced, the life of the light emitting elements 5 can be extended.

Moreover, since the refractive index of the microlens array 9 is higher than that of room (ambient) air, the light from the microlens array 9 side could be reflected by the boundary face between the microlens array 9 and the room air. However, since the surface of the microlens array 9 is made uneven with the convex lenses 9a, the light hardly reflects but rather is emitted. Further, the incident light from outside can also be diffusely reflected by the uneven surface of the microlens array 9. Thus, the light-extraction efficiency can be improved resulting in an improvement of the light-emission efficiency, and it is also possible to prevent the display from becoming difficult to recognize by preventing reflection of the incident light.

Also, since the surfaces of the transparent substrate 1 and the microlens array 9 are coated with the AR coat 11, the reflection of the light emitted by the light emitting elements 5 and also the incident light from outside can be even further prevented. Accordingly, the light-emission efficiency can be improved, and the display appearance of the light emitting display panel 12 can also be improved.

Furthermore, since the microlens array 9 is made of thermosetting resin that is easy to mold, the cost of the light emitting display panel 12 can be reduced.

Accordingly, the light emitting display panel 12 as described above is suitable for articles that are expected to be used in bright places or mobile equipment that require low power consumption such as a cellular phone, a personal digital assistant (PDA), or an in-vehicle TV.

Second Embodiment

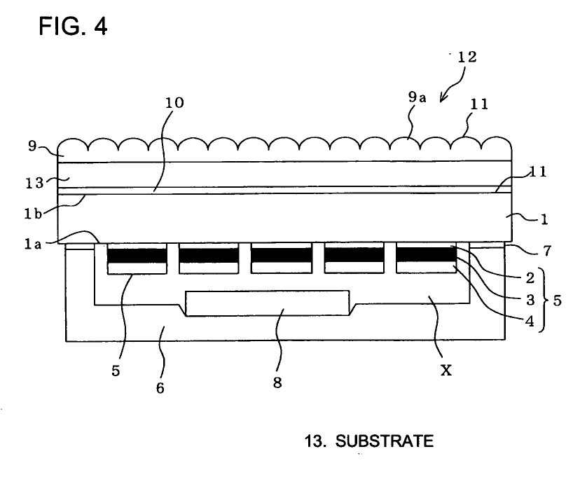

FIG. 4 is for explaining a structure of the second embodiment of the present invention. In the second embodiment, the light emitting display panel 12 of the first embodiment further comprises a substrate 13 which, instead of the microlens array 9, is adhered with the other surface (the upper surface) 1b of the transparent substrate 1 via the adhesive 10, the substrate 13 being made of the same material as the transparent substrate 1 and having the microlens array 9 disposed on one surface (the upper surface) thereof.

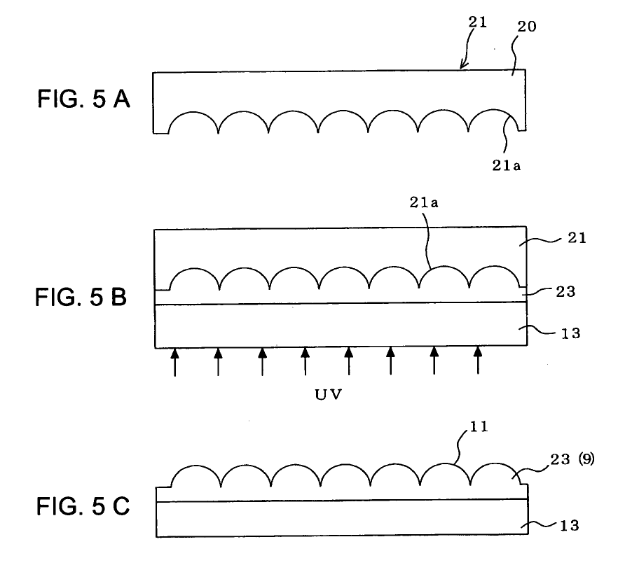

A method of manufacturing the microlens array 9 is explained herein using a process chart shown in FIGS. 5A-5C.

As shown in FIG. 5A, first, polysilicon is applied on a outer surface of a quartz glass plate 20 that is to be a mold of the microlens array 9 with holes (depressions) provided on one surface (the lower surface) of the quartz glass plate 20, each hole corresponding to each of the convex lenses 9a, and then the quartz glass plate is wet-etched to form the mold 21. Then a water repellent finish is applied to the mold 21, especially the side of concave portions 21a thereof that make convex lenses 9a by blowing carbon fluoride (CF) gas that prevents adhesion thereto.

As shown in FIG. 5B, next, thermosetting resin 23 that is to form the microlens array 9 is applied on the one surface (the upper surface) of the substrate 13 made of glass with a predetermined thickness. The mold 21 is then adhered with the thermosetting resin 23 in vacuum so that no bubbles invade between the mold 21 and the thermosetting resin 23. Then, the thermosetting resin 23 is cured by irradiating light such as UV rays from the other surface (the lower surface) of the substrate 13 to mold the thermosetting resin 23 into the shape of the mold 21.

As shown in FIG. 5C, next, the mold 21 is peeled from the cured thermosetting resin 23. Then, the AR coat is applied to the surfaces of the substrate 13 and the thermosetting resin 23 to complete the microlens array 9 with the substrate 13 adhered therewith. At this time, since the water repellent finish is applied to the mold 21, it is easy to peel off the mold 21.

An assembly of the microlens array 9 and the substrate 13 thus manufactured is, as shown in FIG. 4, adhered to the other surface (the upper surface) 1b of the transparent substrate 1 via the adhesive 10 so that the microlens array 9 side is positioned on the upper side, the transparent substrate 1 having the plurality of light emitting elements 5 on the one surface (the lower surface) 1a thereof sealed with the sealing member 6. This assembly, together with a circuit board not shown in the drawings having a drive circuit for driving the light emitting elements 5, forms the light emitting display panel 12.

Being thus structured, substantially the same action and effectiveness of the first embodiment can be obtained. In addition to this, since the microlens array 9 can be formed on a flat surface of the substrate 13, microfabrication technologies can be utilized to make the microlens array 9 very fine. Thus, the reflection of incident light can be prevented to provide a clearer image display in a bright condition. Also, the microlens can be manufactured with fewer manufacturing steps, which can reduce the manufacturing cost of the light emitting display panel 12.

Third Embodiment

In the third embodiment, the light emitting display panel 12 of the second embodiment comprises, instead of the substrate 13 on which the microlens array 9 is adhered, the substrate 14 on which the microlens array 9 is formed by processing the substrate 14 itself adhered with the transparent substrate 1 via the adhesive 10.

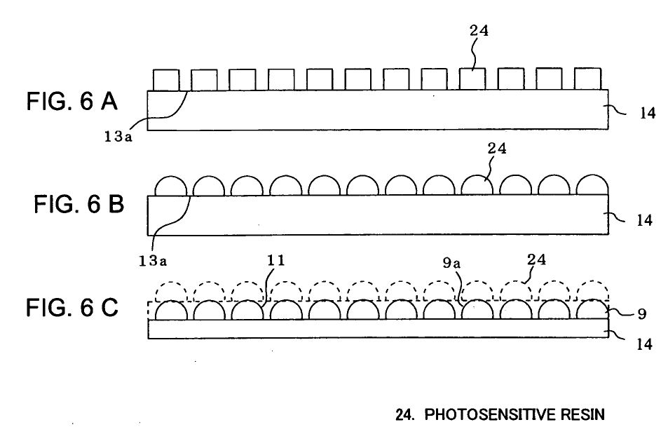

A method of manufacturing the microlens array 9 is explained herein using a process chart shown in FIGS. 6A-C.

As shown in FIG. 6A, first, one surface of the substrate 14 made of the same material as the transparent substrate 1 is coated with photosensitive resin 24, and the photosensitive resin 24 is patterned by a photolithography process so that the photosensitive resin 24 is formed on each pixel corresponding to the convex lens 9a of the microlens array 9.

As shown in FIG. 6B, then the patterned photosensitive resin 24 is shaped into the convex lens 9a of the microlens array 9 by heating to round the surface thereof (thermal reflow).

As shown in FIG. 6C, after that, the shape of the convex lens 9a formed by the photosensitive resin 24 is transferred to the substrate 14 by a dry-etching method to form the microlens array 9 comprising a plurality of convex lenses 9a on the one surface (the upper surface) of the substrate 14. Then the surfaces of the substrate 14 and the microlens array 9 are coated with the AR coat.

The microlens array 9 thus formed by directly processing the substrate 14 adhered with the other surface (the upper surface) 1b of the transparent substrate 1 via the adhesive 10 so that the microlens array 9 side is positioned on the upper side, the transparent substrate 1 having the plurality of light emitting elements 5 on the one surface (the lower surface) 1a thereof sealed with the sealing member 6. This assembly, together with a circuit board not shown in the drawings having a drive circuit for driving the light emitting elements 5, forms the light emitting display panel 12.

Being thus structured, substantially the same action and effectiveness of the second embodiment can be obtained. In addition to this, since the microlens array 9 is itself made of glass that is hard, the microlens array 9 is durable against wear even if it is exposed to the outside. Thus, a light emitting display panel 12 having a surface durable against scratches and difficult to damage can be provided.

The entire disclosure of Japanese Patent Application No. 2003-025730 filed Feb. 3, 2003 is incorporated by reference.

What is claimed is:

1. A light emitting display panel, comprising:
a transparent substrate having a light emitting element on a first surface thereof, a second surface of the transparent substrate defining a display surface; and
a microlens array disposed above the second surface of the transparent substrate.

2. The light emitting display panel according to claim 1, wherein the microlens array is adhered to the second surface of the transparent substrate via adhesive.

3. The light emitting display panel according to claim 2, wherein the adhesive is made of a transparent material having a refraction index that is substantially equal to or higher than a refractive index of the transparent substrate and substantially equal to or lower than a refractive index of the microlens array.

4. The light emitting display panel according to claim 3, wherein the adhesive is made of a material that cures at a temperature lower than a glass transition point of a material forming the light emitting element.

5. The light emitting display panel according to claim 3, wherein the adhesive is made of a material that is curable by visible radiation.

6. The light emitting display panel according to claim 1, wherein:
the microlens array is disposed on a first surface of a substrate made of the same material as the transparent substrate; and
a second surface of the substrate is adhered to the second surface of the transparent substrate via adhesive.

7. The light emitting display panel according to claim 6, wherein the adhesive is made of a transparent material having a refraction index that is substantially equal to or higher than a refractive index of the transparent substrate and substantially equal to or lower than a refractive index of the microlens array.

8. The light emitting display panel according to claim 7, wherein the adhesive is made of a material that cures at a temperature lower than a glass transition point of a material forming the light emitting element.

9. The light emitting display panel according to claim 7, wherein the adhesive is made of a material that is curable by visible radiation.

10. The light emitting display panel according to claim 1, wherein the microlens array is made of a transparent material having a refraction index substantially equal to or higher than a refractive index of the transparent substrate.

11. The light emitting display panel according to claim 4, wherein the adhesive is made of a transparent material having a refraction index that is substantially equal to or higher than the refractive index of the transparent substrate and substantially equal to or lower than a refractive index of the microlens array.

12. The light emitting display panel according to claim 11, wherein the adhesive is made of a material that cures at a temperature lower than a glass transition point of a material forming the light emitting element.

13. The light emitting display panel according to claim 11, wherein the adhesive is made of a material that is curable by visible radiation.

14. The light emitting display panel according to claim 1, wherein the microlens array comprises a plurality of convex microlenses having a size within a range of 1 through 100 micrometers.

15. The light emitting display panel according to claim 1, wherein the light emitting element comprises a sequential stack of at least a transparent electrode, a light emitting layer, and a metal electrode above the first surface of the transparent substrate in this order.

16. The light emitting display panel according to claim 15, wherein the light emitting layer comprises a layer of an organic electroluminescent material.

17. The light emitting display panel according to claim 1, wherein an antireflective agent is applied on at least the second surface of the transparent substrate and the surface of the microlens array.

18. A method of manufacturing a light emitting display panel equipped with a light emitting element on a first surface of a first transparent substrate and a microlens array on a second surface of the first transparent substrate, comprising:
(a) coating a second transparent substrate with resin to be a microlens array;
(b) transferring a shape of the microlens array to the resin by pressing a mold of the microlens array against the resin;
(c) curing the resin; and
(d) forming the microlens array by peeling off the mold from the resin.

19. The method according to claim 18 wherein step (d) comprises:
(e) peeling off the second transparent substrate from the resin.

20. A method of manufacturing a light emitting display panel equipped with a light emitting element on a first surface of a first transparent substrate and a microlens array on a second surface of the first transparent substrate, comprising:
(a) coating a second transparent substrate with photosensitive resin;
(b) patterning the photosensitive resin by a photolithography process so that the photosensitive resin is formed on each pixel corresponding to a convex microlens of the microlens array;
(c) shaping the patterned photosensitive resin into the convex microlens by heating the photosensitive resin; and
(d) forming the microlens array by transferring a shape of the photosensitive resin to the second transparent substrate by simultaneously dry-etching the photosensitive resin and the second transparent substrate.
